(19) United States
(12) Patent Application Publication
(10) Pub. No.: US 2004/0056970 A1
(43) Pub. Date: Mar. 25, 2004

(54) Image capture device

(76) Inventors: Lothar Westerweck, Hollywood, FL (US); Wilfred Bittner, Tsing Yi (HK); Erwin Scholz, Miramar, FL (US)

Correspondence Address: CONCORD CAMERA CORP., 4000 HOLLYWOOD BLVD, #650N, HOLLYWOOD, FL, 33021, US

(21) Appl. No.: 10/670,070

(22) Filed: Sep. 23, 2003

Related U.S. Application Data
(60) Provisional application No. 60/413,079, filed on Sep. 23, 2002.
(60) Provisional application No. 60/488,927, filed on Jul. 21, 2003.
(60) Provisional application No. 60/450,556, filed on Feb. 27, 2003.

(51) Int. Cl. H04N 5/225; G02B 13/16

(52) U.S. Cl. 348/240.3; 348/335

(57) ABSTRACT

A zoom lens system is provided including a flat cam for driving the zoom lens mechanism. In one particular embodiment, the same flat cam used by the zoom lens system is used to correlate the effective focal length of the zoom lens to the viewfinder. Additional particular embodiments of a viewfinder adjustment mechanism are provided wherein the viewfinder adjustment mechanism includes a diopter adjustment mechanism to adjust the ocular lens of the viewfinder to compensate for imperfections in the user's sight.

### PRIORITY

The present application claims priority from co-pending provisional patent application serial number 60/413,079, Filed on Sep. 23, 2002, entitled IMAGE CAPTURE DEVICE and co-pending provisional patent application serial No. 60/488,927, Filed on Jul. 21, 2003, both entitled IMAGE CAPTURE DEVICE, and additionally co-pending provisional patent application serial No. 60/450,556, Filed on Feb. 27, 2003, entitled VIEWFINDER DIOPTER LENS ADJUSTMENT MECHANISM.

### FIELD OF THE INVENTION

The present invention relates to image capture devices and more particularly, to a zoom optical system for an image capture device.

### BACKGROUND OF THE INVENTION

In the interest of making cameras smaller with thinner profiles, optical zoom mechanisms are being necessarily scaled down. Often, the lens barrels of a camera that are responsible for zooming are driven by a cam. There is a need for a zoom mechanism wherein the zoom lens barrels and the driving cam mechanism can be made appropriately compact.

Also, in a camera having an optical zoom lens, there is a problem of correlating the zoom effect undergone by the zoom lens with the scene shown to the user through an optical viewfinder.

When viewing a scene through a viewfinder, it is sometimes necessary to fine tune the viewfinder assembly to accommodate for less than perfect vision of the photographer.

What is needed is a zoom optical system that can be made compactly and still be accurately experienced by the user.

### SUMMARY OF THE INVENTION

A zoom lens system is provided including a flat cam for driving the zoom lens mechanism.

In one particular embodiment, the same flat cam used by the zoom lens system is used to correlate the effective focal length of the zoom lens to the viewfinder.

Additional particular embodiments of a viewfinder adjustment mechanism are provided wherein the viewfinder adjustment mechanism includes a diopter adjustment mechanism to adjust the ocular lens of the viewfinder to compensate for imperfections in the user's sight.

Other particular features and embodiments will become apparent from the following detailed disclosure of the invention.

### BRIEF DESCRIPTION OF THE DRAWINGS

The foregoing summary, as well as the following detailed description of the preferred embodiments, is better understood when read in conjunction with the appended drawings. For the purpose of illustrating the invention, there is shown in the drawings an exemplary embodiment that is presently preferred, it being understood however, that the invention is not limited to the specific methods and instrumentality's disclosed. Additionally, like reference numerals represent like items throughout the drawings. In the drawings:

FIG. 1 is a front plan view of the image capture device in accordance with one embodiment of the present invention, wherein a lens cover has been opened to expose the taking lens and viewfinder front apertures.

FIG. 2 is a rear plan view of an image capture device in accordance with one particular embodiment of the present inventions.

FIGS. 3-7 are views of a zoom lens device in accordance with one particular embodiment of the present invention.

FIGS. 8-11 are views taken from differing angles of a flat cam in accordance with one particular embodiment of the present invention.

FIG. 12 is a top perspective view of zoom lens housing in accordance with one particular embodiment of the present invention.

FIGS. 13-20 and 22-23 are various views of a viewfinder assembly in accordance with one particular embodiment of the present invention.

FIG. 21 is a perspective view of a portion of the zoom lens housing including a cam flat and viewfinder assembly in accordance with one particular embodiment of the present invention.

FIGS. 24-26 are partial perspective views of a cam flat with noise reducing spring in accordance with one particular embodiment of the present invention.

FIG. 27 is a perspective view of a spring useful with one embodiment of the present invention.

FIG. 28 is bottom elevational view of a cam flat in accordance with another embodiment of the present inventions.

FIG. 29 is a bottom elevational view of viewfinder guide levers and an adjustment plate in accordance with another embodiment of the present inventions.

FIGS. 30 and 31 are top and bottom elevational views, respectively, of the guide levers of FIG. 29 in combination with the cam flat of FIG. 28.

FIG. 32 is a partial cut-away view of a viewfinder assembly showing one embodiment of a diopter adjustment mechanism in accordance with one embodiment of the present invention.

FIG. 33 is a partial perspective view of a portion of a diopter adjustment mechanism in accordance with one particular embodiment of the present invention.

FIG. 34 is an isometric view of a diopter adjustment mechanism including a detent spring in accordance with one particular embodiment of the present invention.

FIG. 35 is a partial perspective view of a portion of an image capture device including one embodiment of a diopter adjustment mechanism of the present invention.

FIG. 36 is a partial perspective view including a translucent portion showing an internal portion of one embodiment of a diopter adjustment mechanism of the present invention.

FIG. 37 is a partial perspective view of an image capture device including one embodiment of a diopter adjustment mechanism of the present invention.

FIG. 38 is a partial front plan view of an image capture device including one embodiment of a diopter adjustment mechanism of the present invention.

FIG. 39 is a partial perspective view of a portion of an image capture device showing details of a part of one embodiment of a diopter adjustment mechanism.

FIG. 40 is a partial perspective view of an image capture device without the back shell showing the front view of one embodiment of a diopter adjustment mechanism.

FIG. 41 is a perspective view showing the rear portion of some of the diopter adjustment mechanism components.

FIG. 42 is a perspective view showing the rear portion of some of the diopter adjustment mechanism components.

FIG. 43 is a rear cutaway perspective view showing the rear portion of some of the diopter adjustment mechanism components.

FIG. 44 is a rear partial perspective view of a diopter adjustment mechanism installed through the back shell of an image capture device in accordance with one embodiment of the present invention.

FIG. 45 is a top plan cut-away view of a diopter mechanism having the mechanism housing removed shown in accordance with one embodiment of the present invention.

FIG. 46 is a top plan cut-away view of a diopter mechanism in accordance with one embodiment of the present invention.

### DETAILED DESCRIPTION OF THE PREFERRED EMBODIMENTS

Before explaining the disclosed embodiments of the present invention in detail, it is to be understood that the invention is not limited in its application to the details of the particular arrangement shown since the invention is capable of other embodiments. Also, the terminology used herein is for the purpose of description and not of limitation.

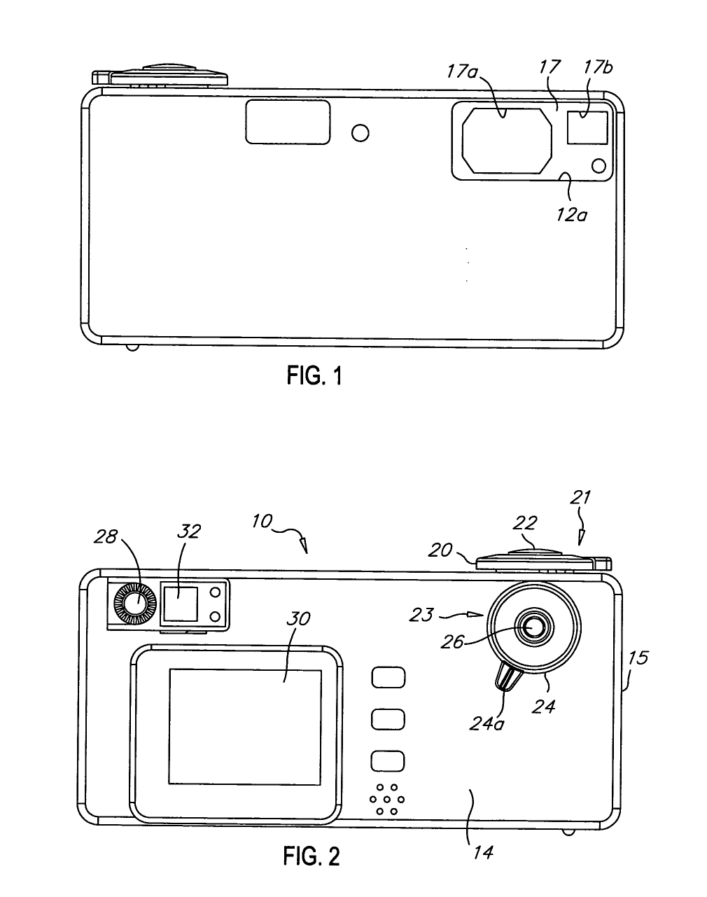

The Image Capture Device Housing Referring now to FIGS. 1 and 2, there is shown an image capture device 10 made in accordance with one particular embodiment of the present invention. Image capture device 10 includes a front housing 12 and a rear housing 14 that matingly engage to surround the internal workings of the image capture device 10. A compartment door 15 may engage either or both of the front and rear housings 12 and 14 to provide access to a battery compartment and/or to output connectors. Such output connectors may be used to connect the image capture device 10 to an external device such as a television, a computer a printer, a cell phone, etc.

Front housing 12 of image capture device 10 includes a plurality of apertures formed therethrough, such as a taking lens/viewfinder window 12a, an aperture 13 for a red eye reduction mechanism and a flash window 18. When the lens door is open, as shown in FIG. 1, the taking lens aperture 17a and viewfinder aperture 17b of the lens mask 17 are exposed.

Rear housing 14 additionally includes a plurality of apertures therethrough. For example, the rear housing 14 of the present particular embodiment includes openings a rotary switch 24, nested tactile switch 26, a rotary diopter adjustment knob 28, an LCD display 30 a view finder rear aperture 32 and signal indicators 34. Other user interface devices, buttons and switches may be included.

A battery door 15 extends across an aperture through a side face of the image capture device 15.

The Zoom Mechanism

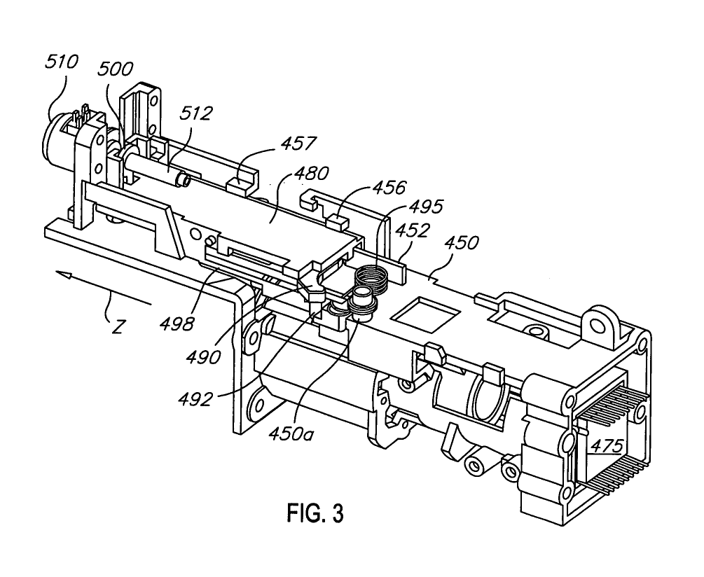

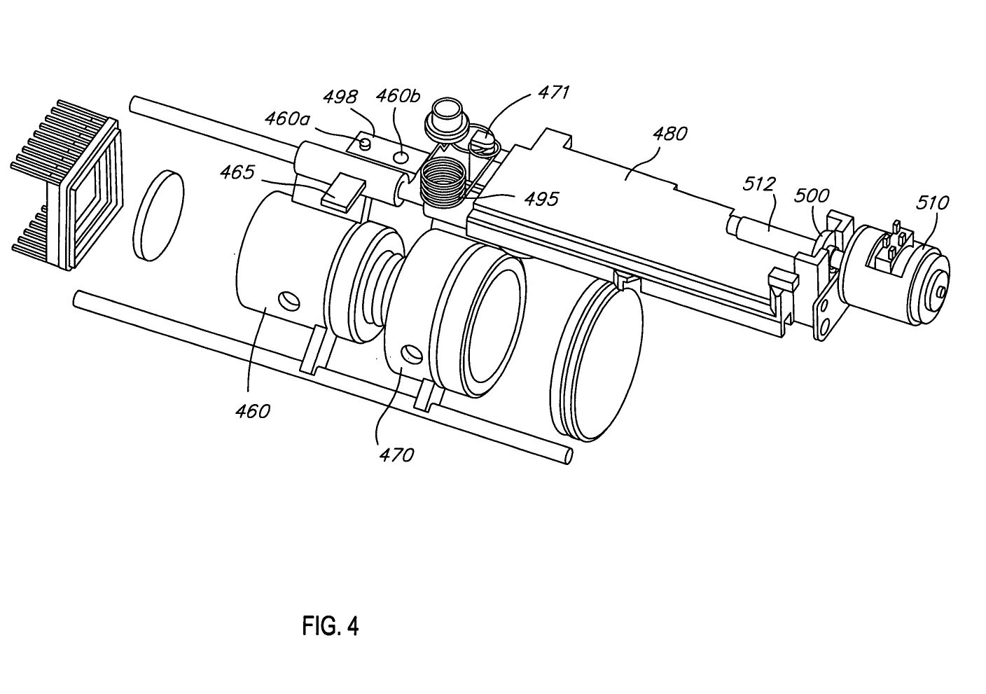

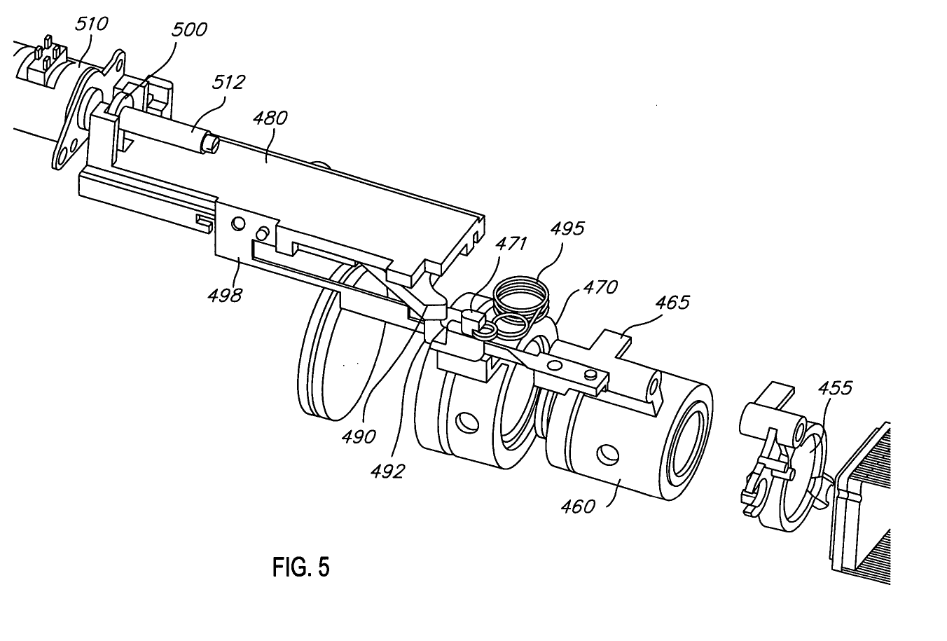

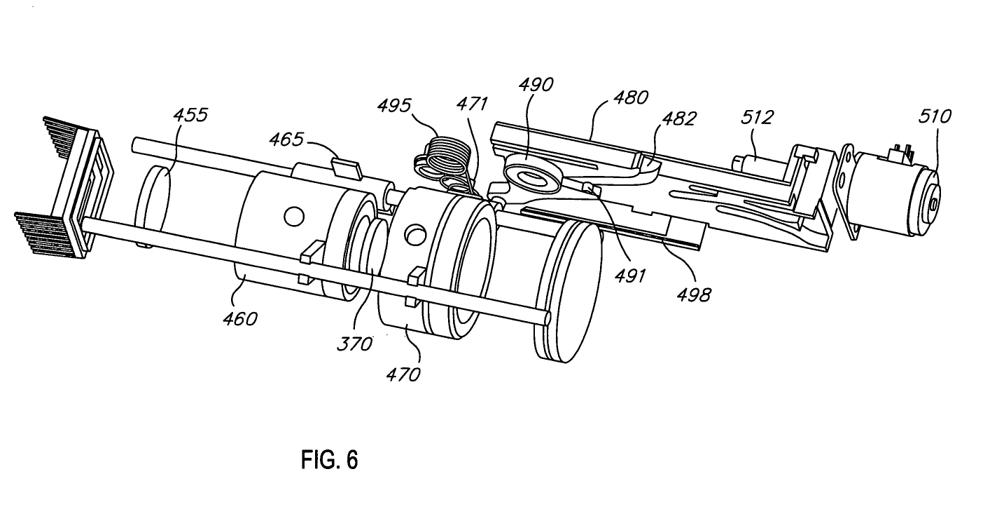

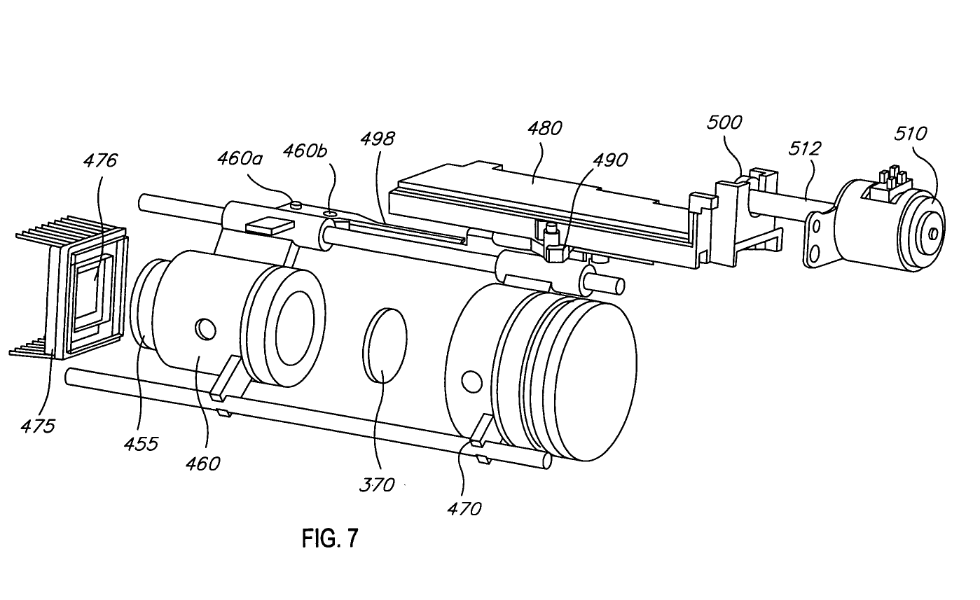

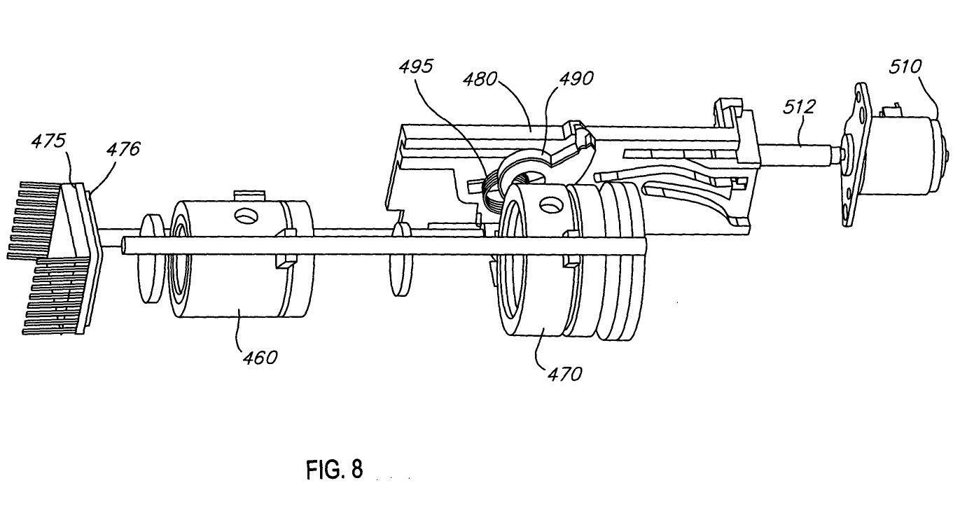

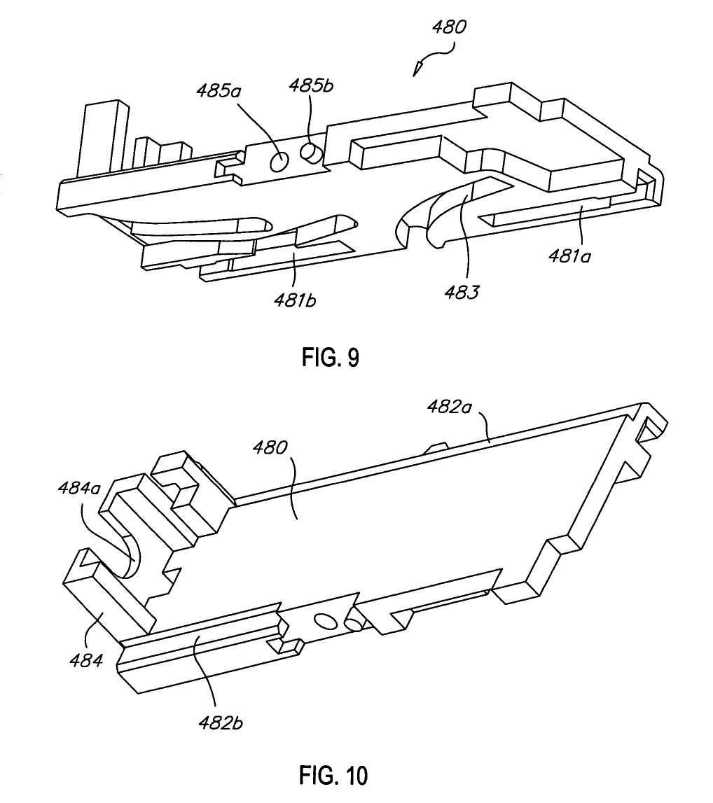

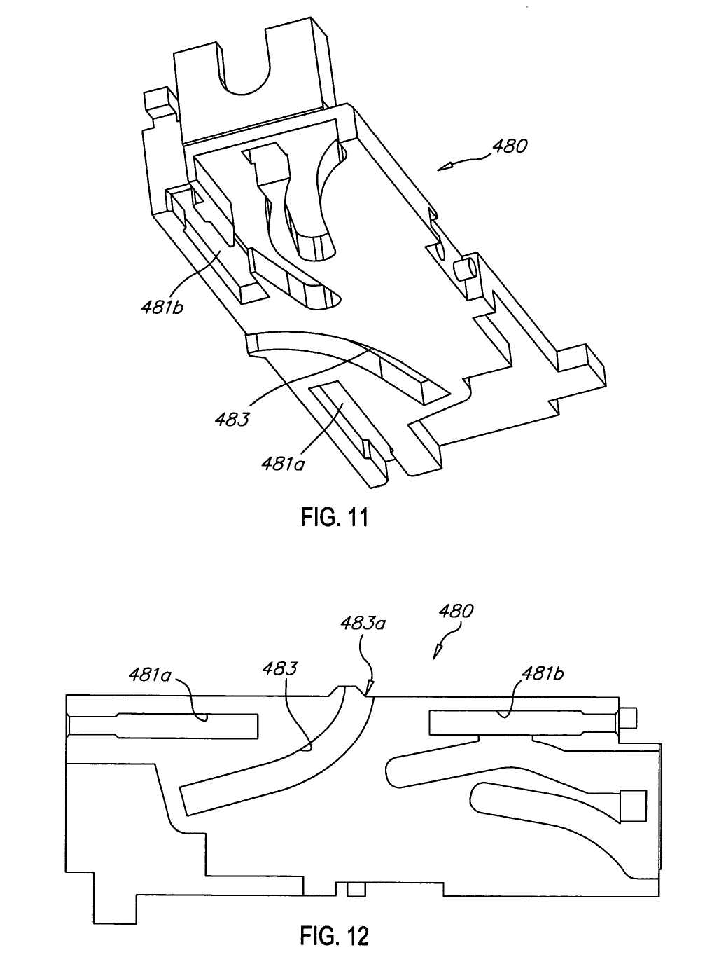

The image capture device 10 may include a zoom mechanism. One particular embodiment of a zoom mechanism that may be used with the image capture device 10 will now be described in connection with FIGS. 3-12. Housed in a zoom housing 450 are the two zoom barrels, front barrel 460 and rear barrel 470. Aligned on the optical axis through the front and rear barrels 460, 470 is an image sensor 475. Other elements may be included in the overall lens design, such as, a shutter lens 370, a focusing lens 455 and glass plate 476.

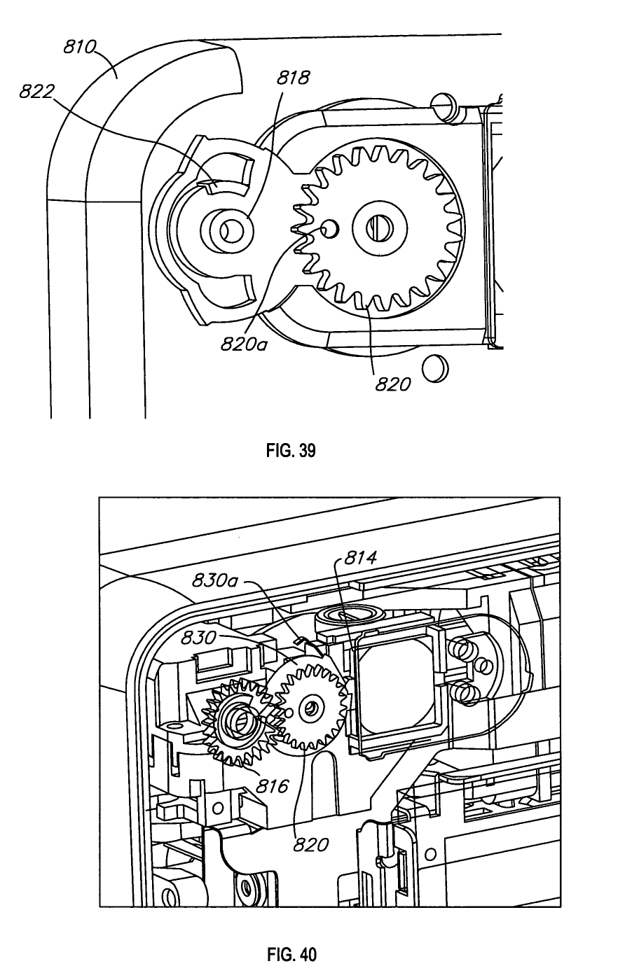

The distance between the front barrel 460 and the rear barrel 470 determines the magnification factor of the image between the wide angle (FIGS. 38 and 39) and the telephoto positions (FIGS. 40 and 41). In the present particular embodiment, a linear cam flat 480 controls the zooming of the image capture device 10 by locating the front and rear lens barrels 460, 470 at discrete positions, each with the barrels 460, 470 a predetermined distance apart.

The cam flat 480 is directly coupled with one barrel (in the present embodiment, the front barrel 460) of the zoom lens via the zoom coupling linkage 498 and is coupled to the other barrel 460 by a zoom lever 490. The cam flat 480 is located on and guided by the zoom housing 450. Guides are realized on the zoom housing 450 by two straight ribs 452, 454 and counter surfaces 456, 457, 458 on the zoom housing 450. These ribs 452, 454 and counter surfaces 456, 457, 458 define the position of the cam in two directions and permit only linear motion. For example, the ribs 452, 454 interact with linear grooves 481a and 481b defined on the bottom surface of the cam flat 480. If desired, tracks, such as tracks 482a and 482b, may additionally be defined on the cam flat 480 to interact with the counter surfaces 456, 457, 458. Due to the counter surfaces 456, 457, 458 contact with the surface, the zoom housing provides a 3 point guide for the cam flat 450. Three small areas near these points but in opposite directions serve the same function. This permits the cam flat 480 to operate even if there is a slight deflection or if there is variation to the tolerances during manufacture, but without a loss of performance.

Additionally, misalignment of the straight ribs 452 and 454 would create high friction or prevent free movement of the cam flat 480. This is avoided by reducing the guide lengths 481a, 481b inside the cam flat 480 to a minimum. Therefore an additional deflection of the cam flat 480 and/or misalignment of the straight ribs 452, 454 will not deteriorate the guide quality.

The non-proportional movement of the zoom lever 490 is realized by the cam profile 482 inside the cam flat 480, which generates the relative positions of both barrels as defined by an optical calculation. As such, when the cam flat 480 advances linearly, the rear barrel 470 is advanced linearly by an amount not directly proportional to the amount of advancement of the cam flat 480, as defined by the cam profile 482. In contrast to this, it can be seen that the front barrel 460, which is directly coupled to the cam flat 480, will be moved by an amount proportional to (if not the same as) the amount moved by the cam flat 480. The integral cam profile 482 followed by the lever 490, is optimized in order to have the lever 490, and correspondingly the lenses, follow a particular optical prescription which incorporates a non-proportional motion.

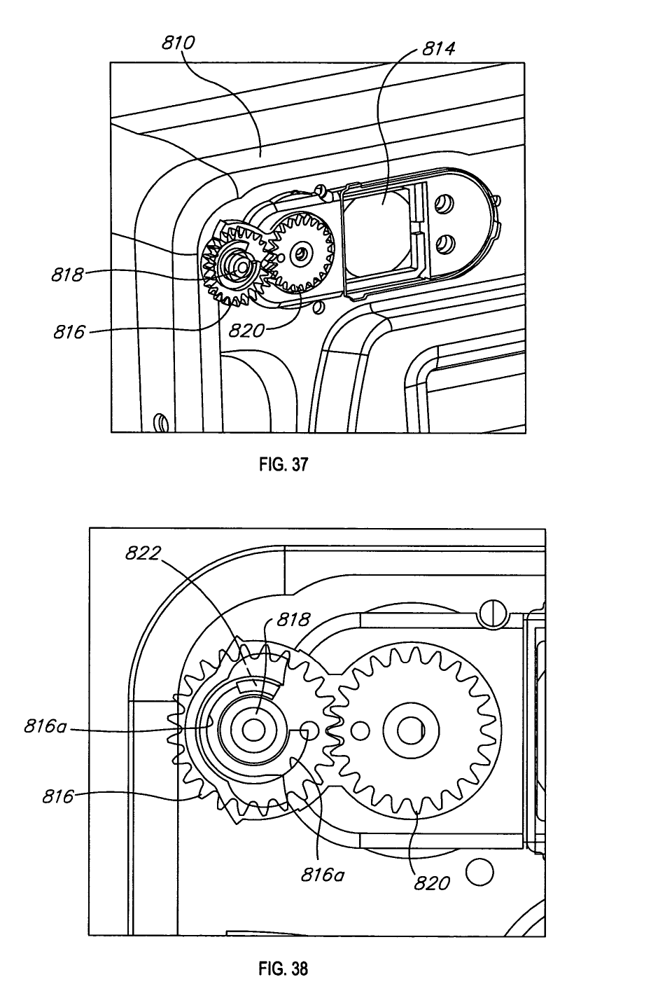

A spring 495 (chosen to be a torsion spring in the present embodiment) is supported on the zoom housing 450 by a pin 450a and presses a finger 471 on the rear barrel 470 against the zoom lever 490, which in turn leans on the inner side of the cam profile 482 to make it follow the prescribed path when the cam flat 480 is moving. A second supporting spring 496 (FIG. 41), which in this particular embodiment, has also been chosen to be a torsion spring, is used to generate an additional force on the cam flat 480. The reason for this spring 496 in this embodiment is to ensure that the cam flat 480 is biased so as to create a force in the direction of arrow Z (FIG. 37) against the nut 500 (FIG. 37) of the driving device, regardless of the position or direction of travel of the cam flat 480. The driving mechanism chosen for the present embodiment includes a stepping motor 510 with a threaded lead screw 512 that passes through the nut 500. Nut 500 includes a finger that passes through an aperture in the cam flat 480 in order to stabilize the nut 500 so that when the threaded lead screw 512 is rotated, the nut 500 does not rotate. The engagement between the cam flat 480, the nut 500 and the threaded lead screw 512 permits the motor to advance and retract the cam flat 480.

Note that in the present embodiment, the cam profile 482 is chosen to be very shallow towards the tele position (and deeper in the wide position) and the force vector of the pin 491 of the zoom lever 490 is nearly zero in the linear direction (not considering friction).

The coupling zoom linkage 498 creates the direct link between the cam flat 480 and the front barrel 460. It is stiff and acts in a push/pull linear manner for precise movement of the front barrel 460, but is flexible for torsion and deflection to compensate for misalignment of the cam flat. The coupling zoom linkage 498 is attached to connector portions 485a and 485b on the side of the cam flat 480, and is similarly attached to the frame of the front lens barrel 460 at connector portions 460a and 460b.

As can be seen from the zoom curve profile, in operation, when the cam flat is advancing away from the motor 510, the directly linked front lens group 460 is additionally advancing away from the motor 510, while the rear group is moving towards the motor 510 and away from the front lens group 460. Similarly, when the cam flat 480 and front lens group 460 are moving towards the motor 510, the rear lens group 470 is moving away from the motor 510 and towards the front lens group 460. As such, it can be seen that during operation of the present particular embodiment, the front and rear lens barrels 460, 470 are always moving in the opposite direction from each other. A finger 465 on the front lens barrel 460 may be used in connection with a photointerrupter (not shown) to inform a processor of the precise location of the lens barrel 460.

One particular method of assembling the mechanism in a simple fashion will be described. In this method, the zoom lever 490 is mounted first, then the barrels 460, 470, and the cam flat 480 is placed last. During assembly, the zoom lever 490 is moved beyond its operational position. At that time the cam flat 480 is slid into place on the housing 450 and the zoom lever 490 is rotated into its position through the open side 483a of the cam profile 483. The coupling zoom linkage 498, is then mounted to the front lens barrel 460 and fixed onto the cam flat 480. Also at this time, the cam drive stepping motor 510 will be engaged with the cam flat 480 at the cam flat yoke 484 and with the nut 500.

It should be understood that other methods of assembling the zoom lens mechanism may be used. Additionally, although in the described embodiment the front barrel 460 is linked to the cam using the cam zoom linkage 498 and the rear barrel 470 using the lever 490, with a slight modification to the cam profile 483, the cam zoom linkage 498 may be used to drive the rear group 470 and the lever 490 used to drive the front group 460.

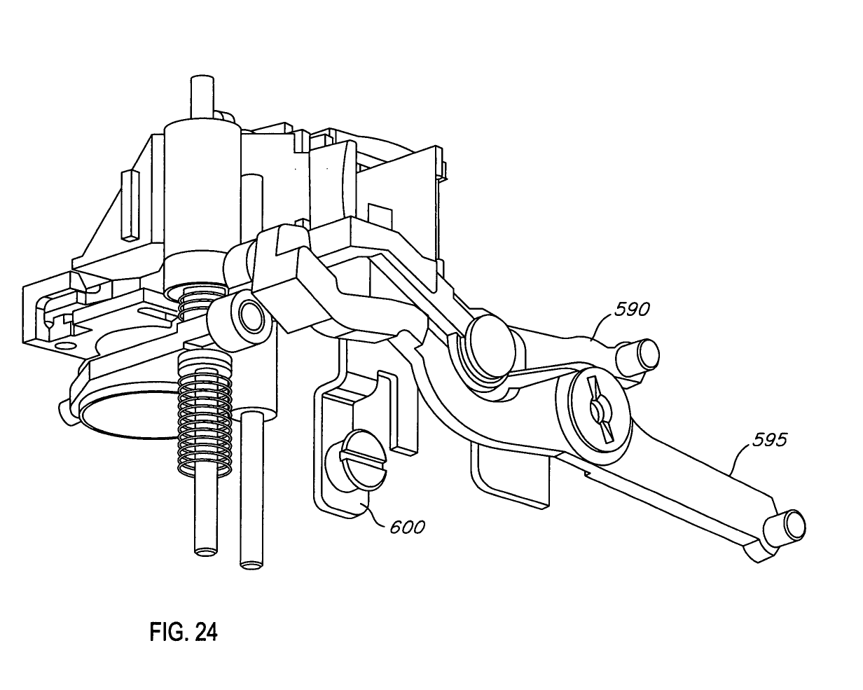

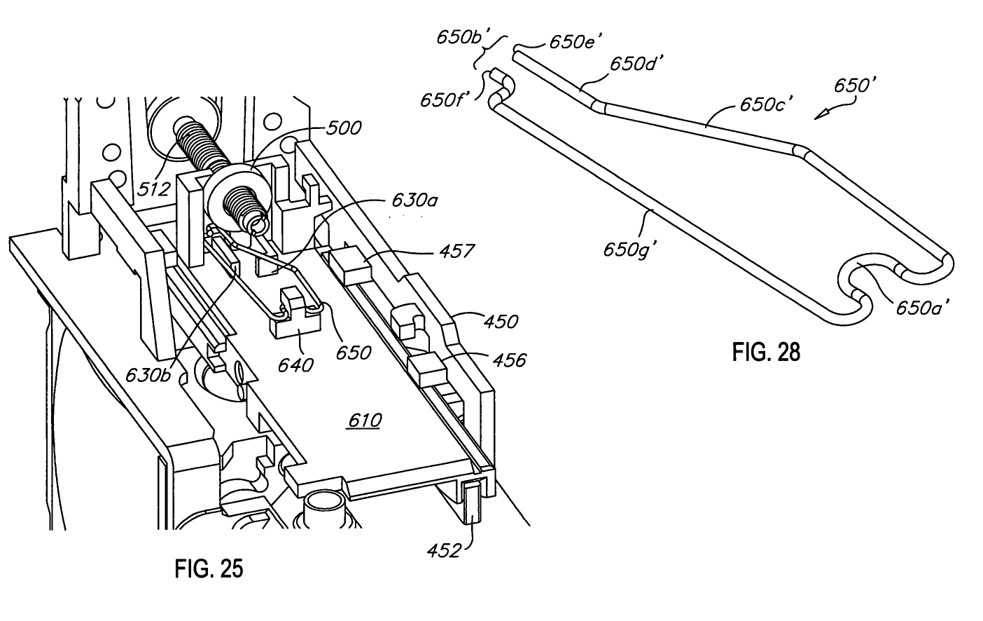

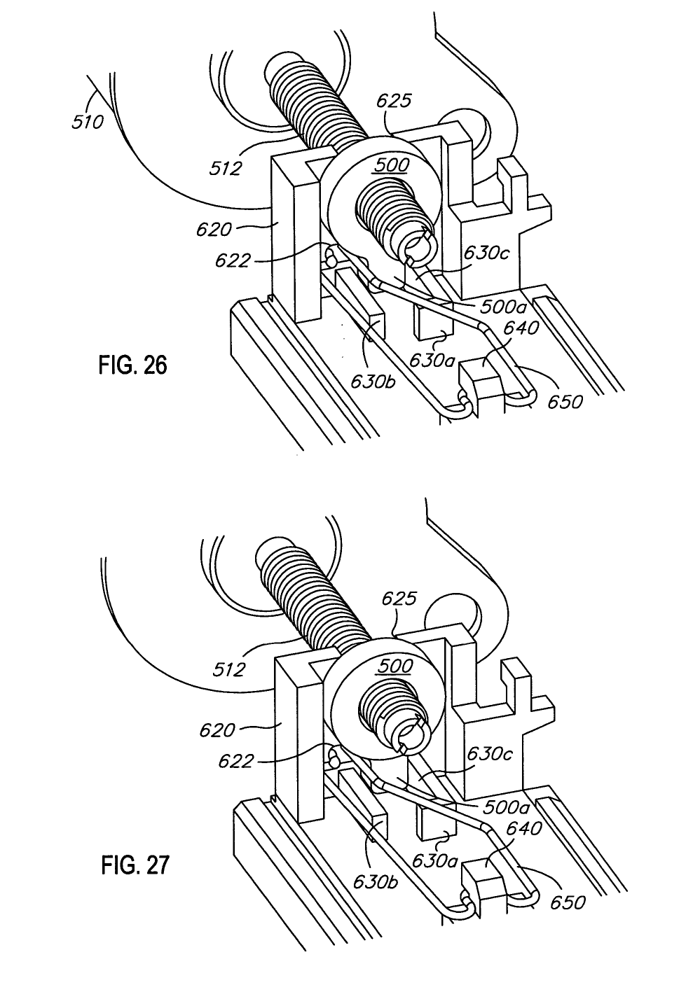

Referring now to FIGS. 24-26, there is shown another embodiment of a cam flat 610, that may be used in the above described system in place of cam flat 480. The cam flat 610 engages the zoom housing 450, as described above in connection with cam flat 480. Additionally, the bottom surface of the cam flat 610 includes the cam profiles, as described in connection with cam profile 483.

Similarly, the cam flat 610 will be driven by the cam drive stepping motor 510. As with the earlier described embodiment, cam drive stepping motor 510 includes a threaded lead screw 512 that passes through the nut 500. The threaded lead screw 512 rests on a cam flat yoke 625, made in the shoulder portion 620. The nut 500 mates with the threaded lead screw 512 on the opposite side of the shoulder 620 from the stepping motor 510.

The cam flat 610 includes on the upper surface thereof, a channel defined by the walls 630a, 630b and the rear wall of the shoulder 620. A finger 500a on the nut 500 is captured in the channel, by the spring 650. The spring 650 is captured at one end by a spur 640 that extends from the upper surface of the cam flat 610 and is fixed at the other end using a hole 622, through the shoulder 620. One leg of the spring clip 650 is used to provide a low force to bias the finger 500a axially (perpendicular to the axis of rotation of the lead screw 512) against the inner surface 630c of the wall 630a, to stabilize the nut 500.

Without the spring 650, the metal nut of the zoom drive would create a noise when the stepping motor was activated. Friction between the nut 500 and the lead screw 512, created by a relatively large axial force on the thread, creates oscillation of the nut 500 as far as mechanically permitted by the channel. The axial friction between the nut 500 the cam flat walls is not enough to prevent this oscillation. It is undesirable for the nut 500 to be too tight against the shoulder 620 because misalignment of the cam flat 610 needs to be compensated for, and additionally, there needs to be as little external forces on the cam flat 610 as possible to achieve the highest possible efficiency.

The spring 650 provides a low force to keep the nut 500 pressed against the cam flat 610 at the reference surface 630c. Additionally, the spring 650 provides a tolerance for the axial displacement of the nut 500 from the cam flat 610 if the motor should overrun a mechanical stop of the cam flat 610. When the motor 510 reverses, proper alignment is re-established, as the nut 500 is maintained in place relative to the threaded lead screw 512 by the spring 650. Additionally, as described above, the spring 650 discourages the oscillation of the nut, and reduces the amount of noise made by the drive mechanism.

If desired, the cam flat 610 may be similar to the cam flat 480 in all other respects.

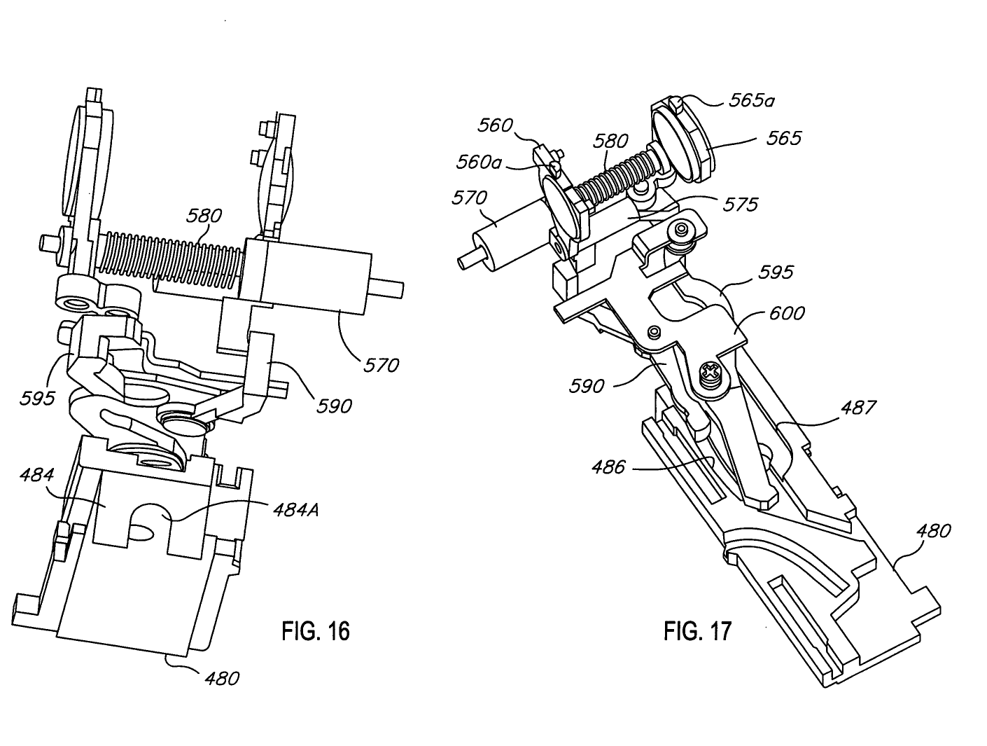

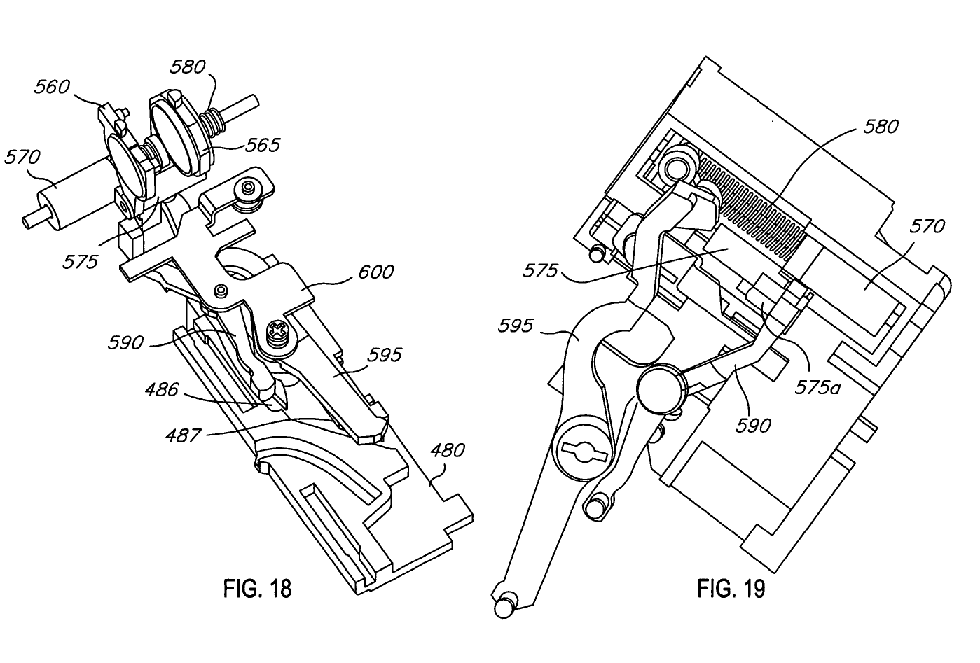

Referring now to FIG. 27, there is shown a spring 650′, which may be used in one embodiment of the present invention. The spring 650′ includes an engagement portion 650a′ for engaging a structure on the cam flat, such as the spur 640 of FIG. 16. Additionally, an open end 650b′ of the spring 650, may be used to further engage a structure on the cam flat, such the hole 622 of FIGS. 17 and 18. To cause such engagement, the legs 650g′ and 650d′ may be pinched towards each other until the ends 650e′ and 650f′ can be inserted into the hole 622, as with the operation of a safety pin. The spring 650 additionally includes a spring bias bent portion 650c′ to create a spring bias on the leg 650d′.

Please note that the use of the spring 650′ as the spring 650 in FIGS. 24-26 is not meant to be limiting. It can be seen how other forms of torsion springs and/or compression springs can be used in connection with the embodiment of FIGS. 24-26 to bias the finger 500a against a portion of the cam flat 610, to stabilize the nut and reduce noise.

A Viewfinder Mechanism

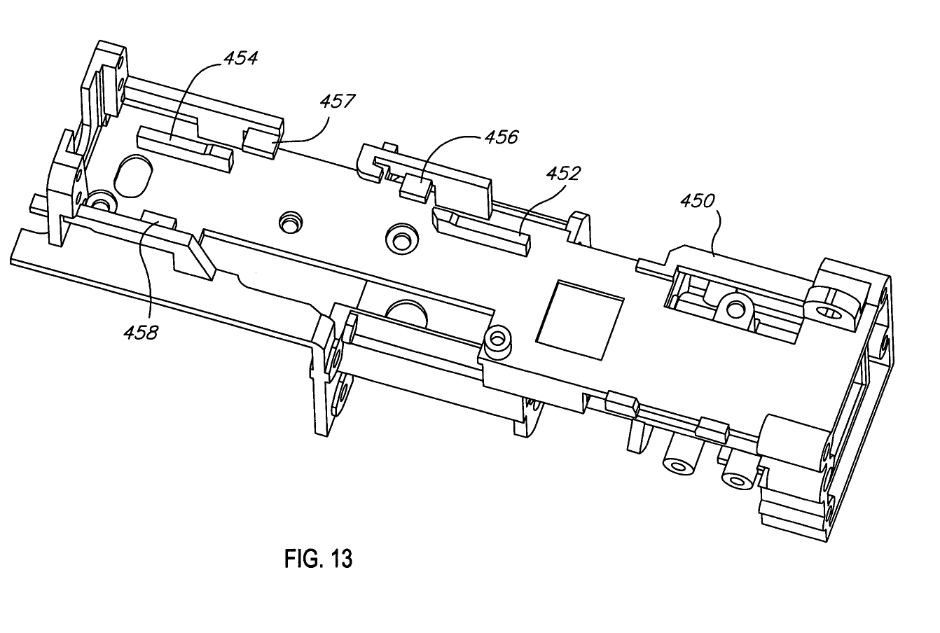

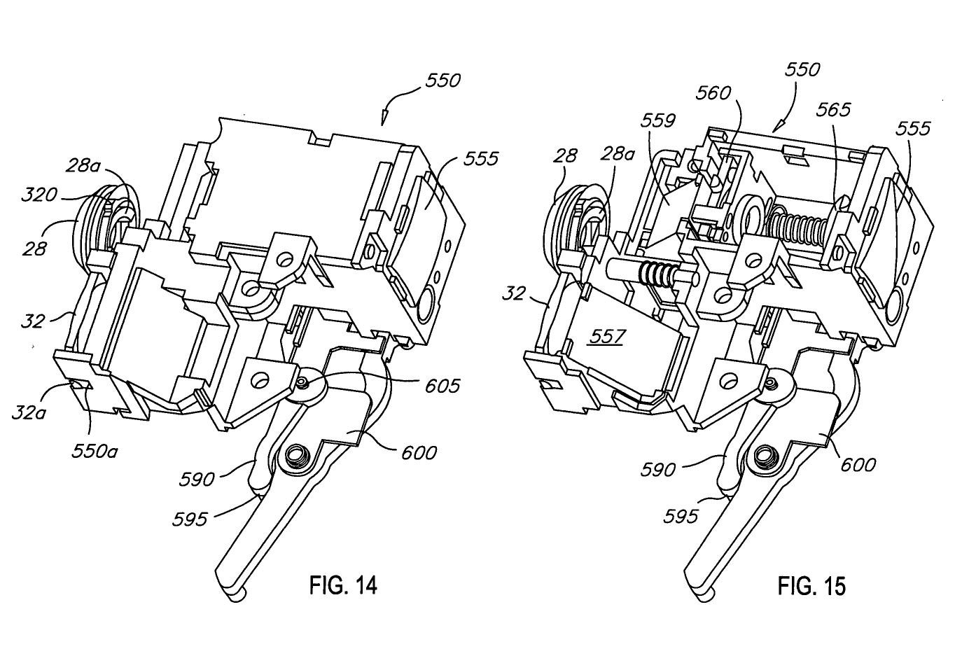

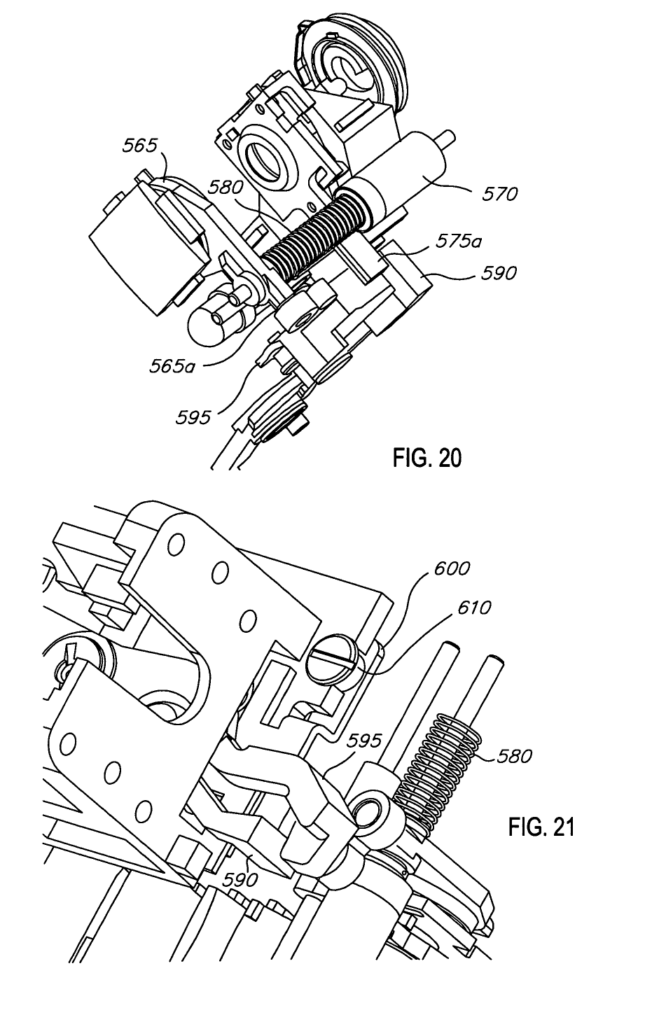

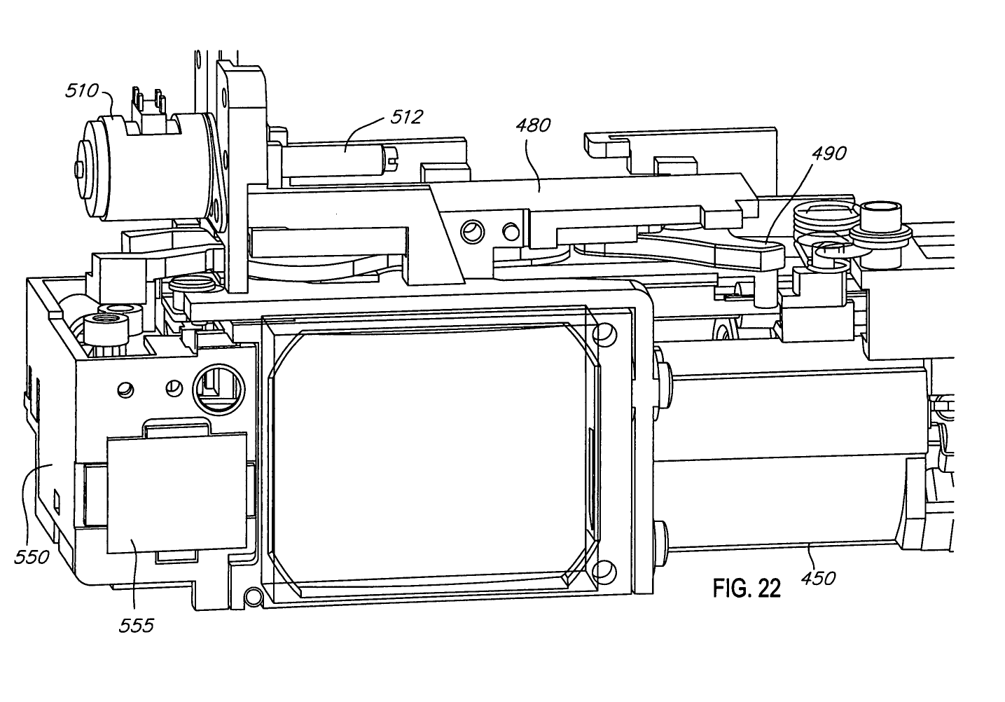

Referring now to FIGS. 13-23, there will be shown a viewfinder mechanism through which the user can view the scene at the same effective magnification chosen by zoom mechanism. A viewfinder housing 550 is located adjacent to the zoom housing 450 (see FIG. 55). All viewfinder lenses are captured in the viewfinder housing 550. The viewfinder housing 550 additionally contains two prisms 557, 559, for directing the view of the user around a turn in the housing 550. The middle lens 565 and the rear lens 560 are guided in the lower portion on pins 575 and 570, which are cylindrical in the present particular embodiment.

In the upper portion, pins 560a and 565a (part of the lenses 560 and 565, respectively) are being guided within a slot (not shown) in the viewfinder cover. An extension spring 580 pushes the rear and the middle lenses 560, 565 apart from one another (See FIGS. 49-51) to allow a constant force on the lens levers 590 and 595. The two lens levers 590 and 595 are captured by an adjustment plate 600. Additionally, pins on the free ends of the levers 590, 595 are captured in grooves 486 and 487 on the cam flat 480, respectively. The levers 590, 595 are driven by the same cam flat 480 as the zoom mechanism, which correspondingly moves the rear and middle lenses 565 and 560 of the viewfinder due to the contact between the lens levers 590, 595 and the lens frame tabs 575a and 565a. As such, as the lens levers 590, 595 move together and apart based on the profiles of the cam grooves 486 and 487 on the cam flat 480, the viewfinder experiences an apparent zooming view that corresponds to the effective zooming action experienced at the image sensor due to the cam flat 480 moving the front and rear zoom barrels 460, 470 of the zoom lens mechanism.

The middle lens lever 595 couples to the middle lens 565 by a connector bearing 565a. The arrangement of the connector bearing 565a is such that it always pulls the lenses into one sideways, direction, thus preventing an erratic sideways motion of the middle lens 565 during zooming. No additional spring is necessary for the prevention of erratic sideways movement.

The rear lens lever 590 interacts with a slanted surface on the pin of the rear lens, which also prevents sideways motion. As such, the two levers 590, 595 are driving, by means of the cam flat 480, the two movable zoom lenses 560, 565 according to the designated motion with the use of only one spring. The spring 580 is captured in a unique way by forcing the lenses always against the lever bearing connection. Backlash is relatively eliminated and a smooth motion of the viewfinder zoom action is secured. The additional connector bearing piece prevents an erratic sideways motion of the lenses during zoom activation.

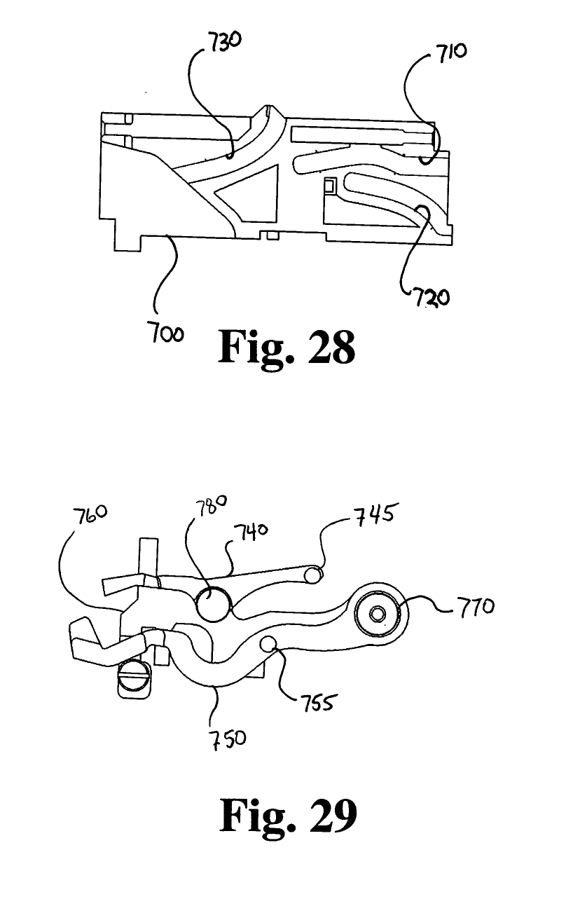

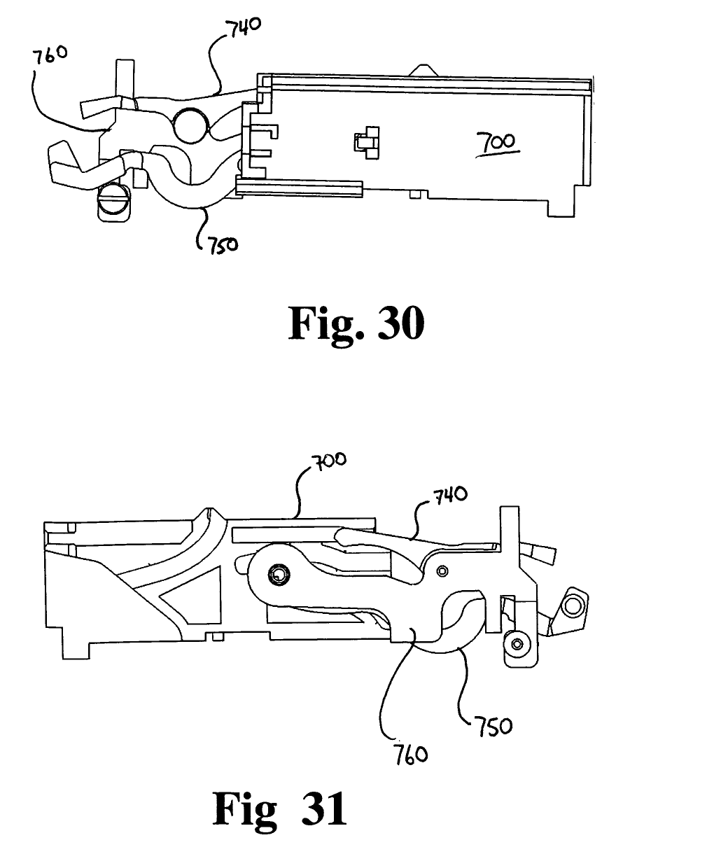

Referring now to FIGS. 28-31, there is shown an alternate embodiment of the design of a cam flat 700 including first and second viewfinder guide grooves 710 and 720, respectively, and an alternate embodiment of a zoom lens guide groove 730. Due to the altered design of the cam grooves in the cam flat 700, the first and second guide levers 740 and 750, respectively, have been redesigned to work with the cam groove profiles of the cam flat 700. As with the other embodiments, the first and second viewfinder guide levers are pivotally fixed to an adjustment plate 760. The guide levers 740 and 750 engage the cam flat at pins 745 and 755, respectively, and follow the viewfinder guide grooves 710 and 720 when the cam flat 700 is moved. The remaining free ends of the guide levers 740 and 750 are used to bias the viewfinder lenses, as described in connection with the above embodiments. Note that in the present embodiment, unlike the previously described embodiment secures the guide lever 750 to the adjustment plate 760 using a pivot pin 770 located at the distal end of the adjustment plate 760 instead of in the middle of the guide lever, as with the pivot pin 780 of the present embodiment, or as with the embodiment of FIGS. 13-21.

Tuning the Viewfinder During Assembly

Referring now To FIGS. 21-23, the rear lens lever 590 and the middle lens lever 595 are captured on an adjustment plate 600. The adjustment plate is located on the zoom structure by a bearing rivet 605, although other means of attachment are possible. An accentor pin 610 is riveted to the adjustment plate as well and guided between a slot of the zoom structure. By turning the accentor pin 610 clockwise or counter clockwise, the adjustment plate 600 can be rotated around the bearing rivet 605. The rear lens lever 590 can now be moved in a rotary motion and in return, through the connection between the rear lenses, moves the rear lens forward and backwards. The rear lens can now be adjusted in the viewfinder lens system to correct any deviation between the lenses. The accentor pin 610 at the same time is being held by friction (in the present embodiment, by the use of a washer) against unwanted rotation. By mounting the two lens levers 590, 595 on one rotational adjustment plate 600 and by the use of one accentor pin 610, an easy adjustment (using merely a screwdriver, in the present embodiment) of the viewfinder lens system is possible.

Viewfinder Diopter Adjustment

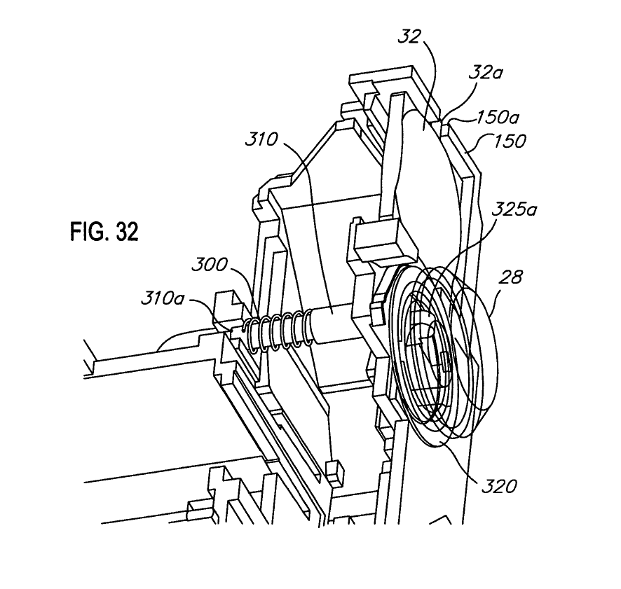

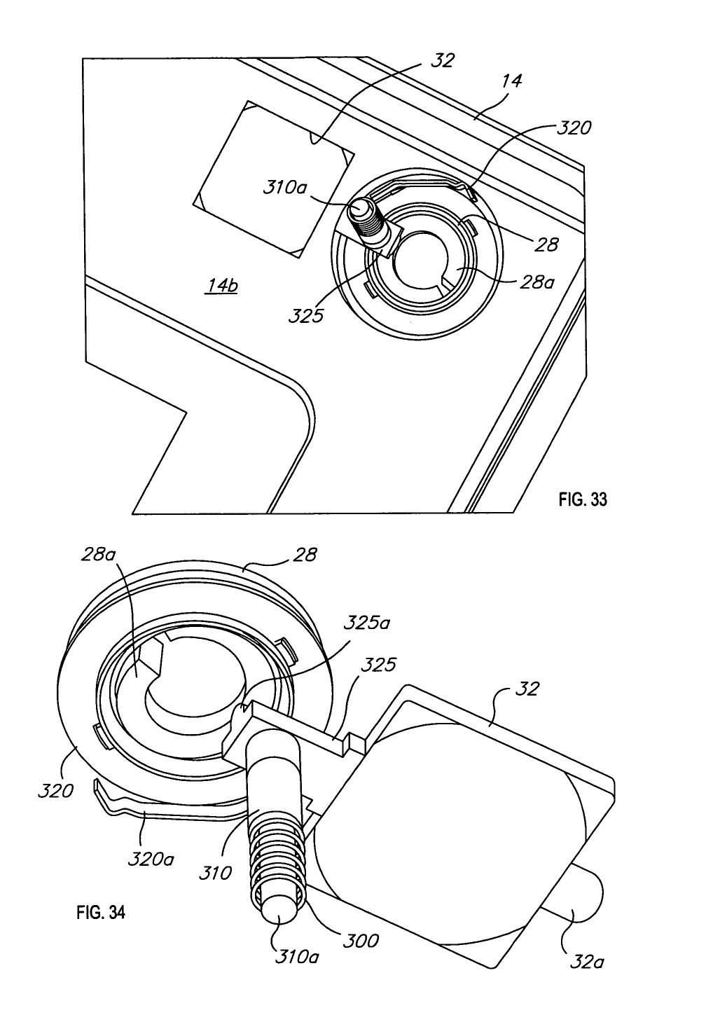

Referring now to FIGS. 2 and 32-34, there is shown one particular embodiment of a viewfinder diopter adjustment mechanism that may be used with an image capture device, such as image capture device 10. The viewfinder eye lens (diopter lens) 32 is adjusted using a knob 28 mounted to the rear housing 14. The eye lens 32 is mounted to the viewfinder housing 550 by means of slot 550a, in which tab 32a is seated. The slot includes enough clearance for the tab 32a to move forward and back, in response to rotation of knob 28. However, rotation of the knob 28 would be limited by the confines of the slot, such that when the tab 32a would hit the front or back end bearing surfaces of the slot, the knob 28 could not be turned further. As will be described below, a detent spring or mechanism may be included to prevent the rotation of the knob to these extremes. The slot bearing area is closed and secured by the viewfinder housing cover (see FIG. 47). Opposite the tab 32a, an arm 325 connects the lens 32 to a bearing pin 310. A protrusion 325a is located on the planar face of the arm 325, opposite the planar face supporting the bearing pin 310.

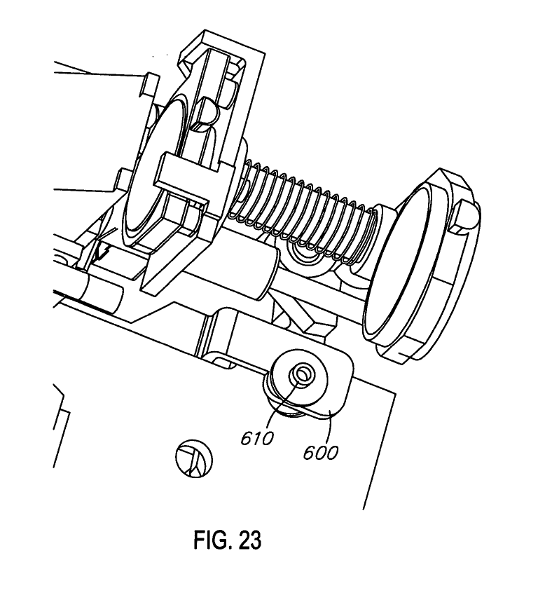

One end 310a of the bearing pin 310 is located in a cylindrical hole in the viewfinder housing 150. A compression spring 300 mounted coaxially around the bearing pin 310 biasing the protrusion 325a against a rotational cam 28a resembling, a helical ramp, which is incorporated within the diopter knob 28. The rotational cam 28a is located in a bearing hole of the back cover 14 of the image capture device 10. By rotating the diopter knob 28 clockwise or counterclockwise, the cam 28a inside the diopter knob 28 rotates, moving the diopter lens forward or backward, as the protrusion 325a is biased against portions of the ramp having greater or lesser heights. This movement of the diopter lens enables the user to adjust the sharpness of the viewfinder zoom lens system. As can be seen more particularly in FIG. 23, the coil spring 300is compressed between a bearing shoulder on the bearing pin 310 and the viewfinder housing 150. As the knob 28 is rotated, the compression spring 300 maintains the protrusion 325a in contact with the cam 28a based on the force on the bearing shoulder of the bearing pin 310 compressing or decompressing the spring 300 against the viewfinder housing 150 as the cam ramp 28a height increases or decreases, respectively. As can be seen, the change in height of the ramp 28a results in a corresponding linear movement of the viewfinder diopter lens 32.

Additionally, a detent spring 320 having a frictional spring arm 320a is connected to the diopter knob 28 against the inner surface 14b of the rear housing 14. Inner surface 14b should include a number of detent notches, not shown, with which to engage the frictional spring arm 320a when the diopter knob 28 is turned. This serves to capture the frictional spring arm 320a to prevent unintentional movement of the diopter knob 28. The detent spring 320 can be used as a friction position device or as a detent mechanism. The diopter knob 28 may be fastened to the rear cover by means of a heat stake or ultrasonic welding.

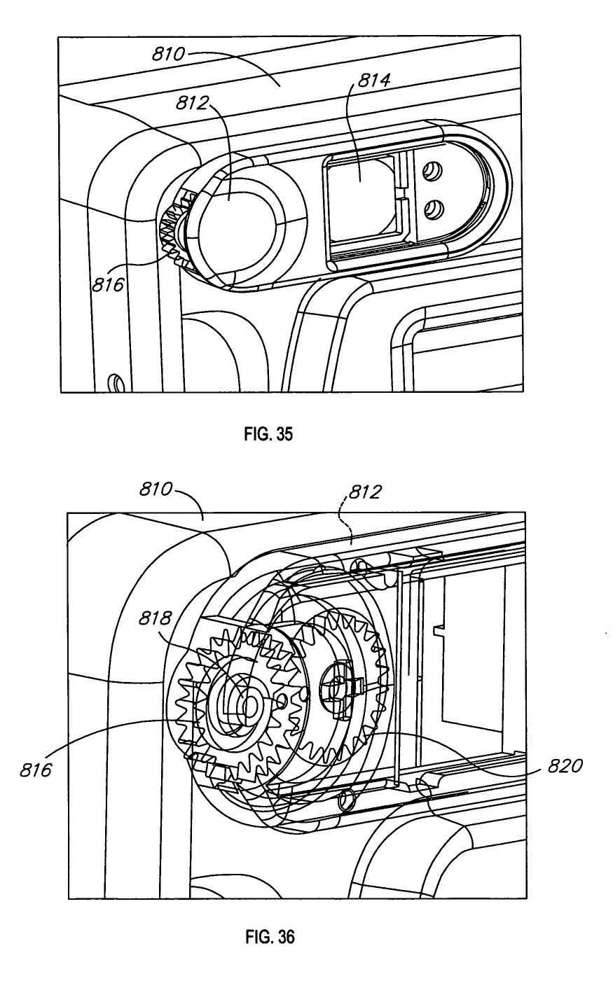

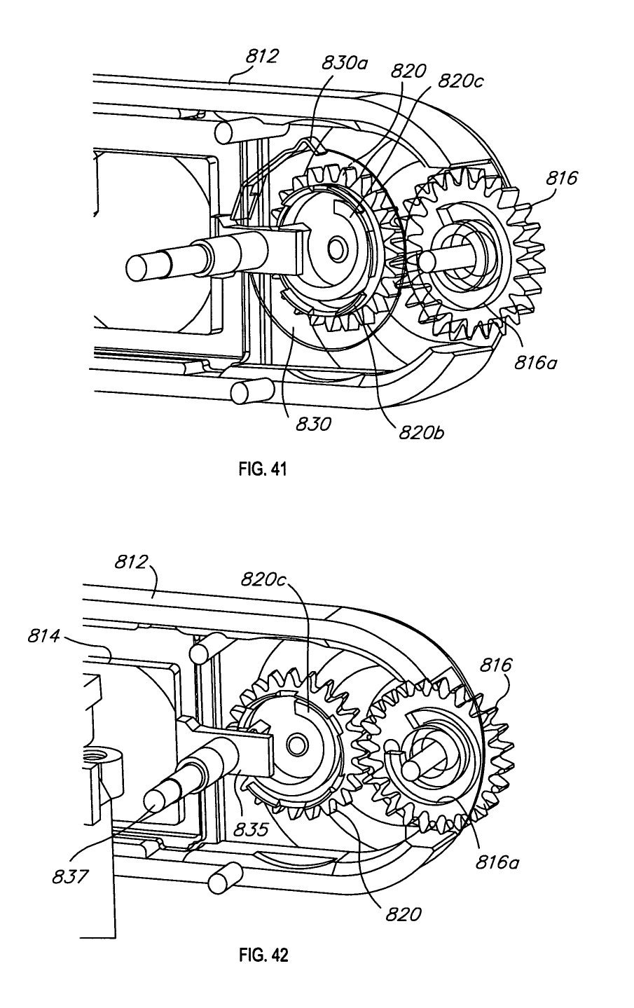

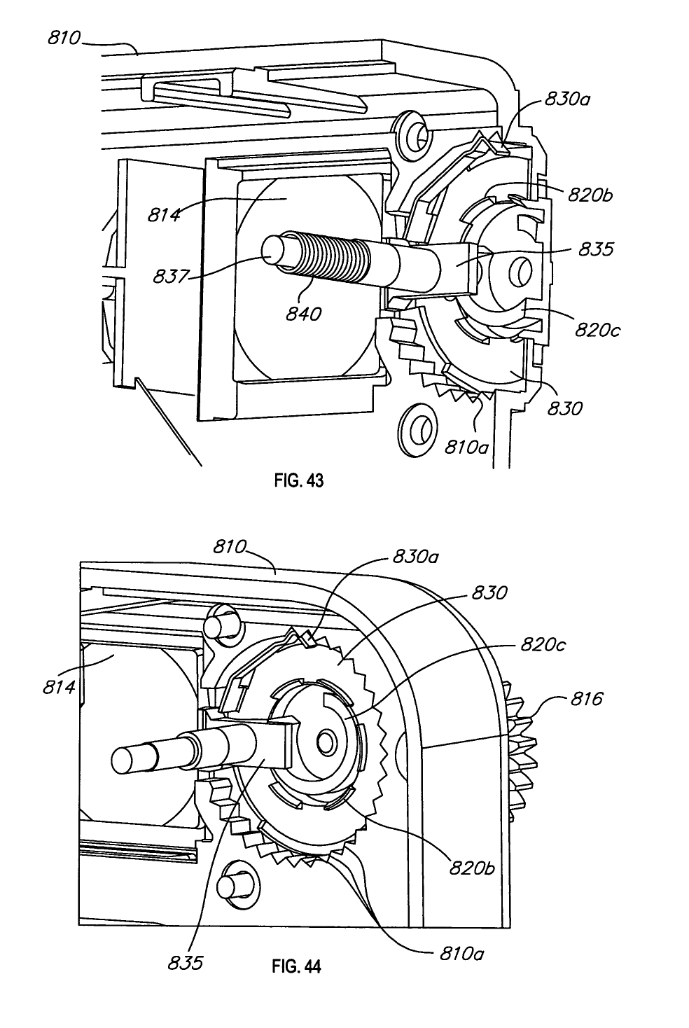

Referring now to FIGS. 35-46, there is shown another embodiment of a diopter adjustment mechanism in accordance with the present invention. The image capture device includes a back shell 810 upon which is located a mechanism cover 812 for the viewfinder diopter adjustment mechanism. Additionally located on the rear cover 810, is the viewfinder ocular lens or diopter lens 814, the position of which is adjusted by the diopter adjustment mechanism of the present invention. Extending through the mechanism cover 812 is the diopter wheel 816. Diopter wheel 816 is a toothed gear rotatable by the thumb or finger of the user.

Referring now to FIGS. 36-40, beneath the diopter mechanism cover 812, the diopter wheel 16 is mounted on a bearing pin or post 818 extending from the back shell 810. The teeth of the diopter wheel engage the teeth of the diopter knob gear 820, as shown. Additionally, an end position stop block 822 is molded on the back shell 810, near the post 818. The end positions of the diopter wheel 816 are determined by a slot 816a configured in the rear surface of the diopter wheel 816 and by the stop block 822 on the back shell 810. As such, the diopter wheel 816 may be adjusted clockwise/counterclockwise to the limits of the slot 816a, until the stop block 822 contacts an end of the slot 816a and stops the diopter wheel 816 from turning any further in that direction. As will be discussed more fully below, the diopter knob gear 820 additionally includes an alignment point

Referring now to FIGS. 41-46, there is shown the interaction between the diopter wheel 816, the diopter knob gear 820 and the movement of the diopter lens 814. The reverse of the diopter knob gear 820 has a raised ramp 820c of steadily increasing height and being disposed in a predetermined relationship to the alignment point 820a. Additionally, the reverse portion of the diopter knob gear 820 is heat staked to a detent spring 830 at heat stake portions 820b. The detent spring 830 includes a spring arm 830a which seats in position indentations 810a in the back shell 810. Rotation of the diopter wheel 16 causes the diopter knob gear 820 to correspondingly rotate and to turn the detent spring 830 such that spring arm 830a rests and locks in the discrete locations defined by the indentations 810a, to keep the gear 820 from drifting.

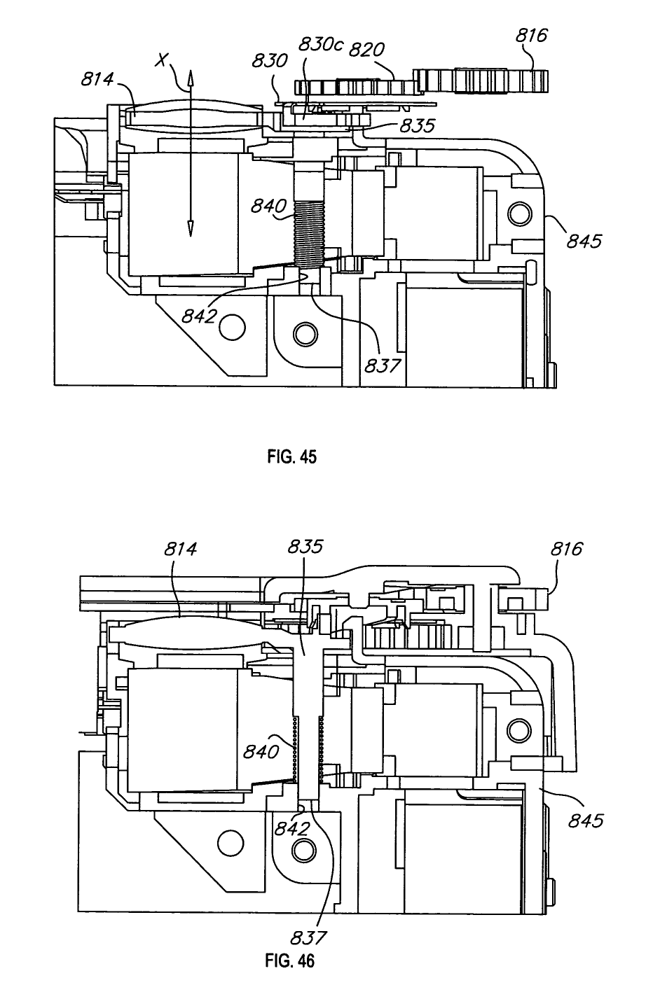

Additionally, the viewfinder ocular lens 814 includes a cam following arm 835 extending outward therefrom. The cam following arm 835 rests against the top surface of the ramp 820c. A bearing pin 837 including a spring 840 thereround, which continuously biases the cam following arm 835 against the ramp 820c. When the detent knob gear 820 rotates clockwise/counter-clockwise, the cam following arm 835 follows the ramp 820c, which converts the rotational motion of the knob gear 820 into linear motion of the ocular lens 814. The bearing pin 837 fits into a recess 842 in the image capture device body 845, thus ensuring that the spring 840 constantly applies pressure between the image device body and the cam following arm 835, maintaining the arm 835 in continuous contact with the ramp 820c. As the cam follower arm 835 follows the ramp 820c, the ocular lens 814 of the viewfinder moves linearly along the viewfinder axis X (FIG. 45). As can be understood, the present diopter adjustment mechanism is for fine-tuning of the viewfinder ocular/diopter lens only. The viewfinder ocular lens' maximum amount of linear movement along the viewfinder axis X is defined by the total change in height ramp 820c portion that the arm 835 is permitted to travel, based upon the final positions of the stop block 822 in the groove 816a (FIG. 38).

While the invention has been described with reference to certain embodiments, it will be understood by those skilled in the art that various changes may be made and equivalents may be substituted for elements thereof without departing from the scope of the invention. In addition, many modifications can be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A zoom lens system, comprising:
a first zoom lens;
a second zoom lens aligned optically with said first zoom lens;
a cam flat including a zoom guide groove having a non-linear profile located on one side thereof;
a zoom lever in communication with said first zoom lens and said non-linear zoom guide groove;
a driving mechanism for driving said cam flat linearly;
wherein linear movement of said cam flat results in said first lens being driven a non-proportional amount by said zoom lever.

2. The zoom lens system of claim 1, wherein movement of said cam flat additionally moves said second zoom lens;

3. The zoom lens system of claim 2, wherein movement of said cam flat directly drives said second zoom lens in an amount proportional to the amount moved by said cam flat.

4. The zoom lens system of claim 3, wherein said second zoom lens is coupled to said cam flat by a zoom coupling linkage.

5. The zoom lens system of claim 2, additionally including a spring fixed relative to said first zoom lens to bias said first zoom lens against said zoom lever and to maintain a portion of said zoom lever in communication with said zoom guide groove.

6. The zoom lens system of claim 5, wherein said driving mechanism includes a stepping motor including a threaded lead screw and a nut engaged with said threaded lead screw, said nut being linked to said cam flat by a nut finger portion in order to drive said cam flat while said motor rotates said threaded lead screw.

7. The zoom lens system of claim 6, further including a spring biased against an end of said cam flat distal from said nut to further bias said cam flat against said nut during movement of said cam flat.

8. The zoom lens system of claim 6, additionally including at least one reference surface extending outward from the surface of said cam flat opposite the surface having said zoom guide groove, and a spring for biasing said finger portion of said nut against said at least one reference surface of said cam flat during rotation of said threaded lead screw.

9. The zoom lens system of claim 8, wherein said zoom guide groove profile is more shallow towards in a first tele position than in a second wide-position.

10. The zoom lens system of claim 1, wherein said cam flat additionally includes a first viewfinder guide groove having a first viewfinder lens profile and a second viewfinder guide groove having a second viewfinder lens profile, and wherein said zoom lens system additionally includes a zooming viewfinder assembly, including:
a first viewfinder lens;
a second viewfinder lens;
a first viewfinder lever in communication with said first viewfinder lens and said first viewfinder guide groove;
a second viewfinder lever in communication with said second viewfinder lens and said second viewfinder guide groove;
wherein movement of said cam flat additionally moves said first viewfinder lens relative to said second viewfinder lens based on said first and second viewfinder lens profiles.

11. The zoom lens system of claim 10, wherein said zooming viewfinder assembly additionally includes an adjustment plate, said first and second viewfinder levers being pivotally fixed to said adjustment plate.

12. A zooming viewfinder assembly, comprising:
a first viewfinder lens;
a second viewfinder lens aligned optically with said first viewfinder lens;
a cam flat including a first viewfinder guide groove having a first viewfinder lens profile and a second viewfinder guide groove having a second viewfinder lens profile, said cam flat additionally controlling the magnification of a zoom lens;
a first viewfinder lever in communication with said first viewfinder lens and said first viewfinder guide groove;
a second viewfinder lever in communication with said second viewfinder lens and said second viewfinder guide groove; and
a driving mechanism for driving said cam flat linearly.

13. The viewfinder assembly of claim 12, additionally including a spring located between said first viewfinder lens and said second viewfinder lens to push said first and said second viewfinder lenses apart from one another and provide a constant force on said first and second viewfinder levers.

14. The viewfinder assembly of claim 13, additionally including an adjustment plate pivotally fixed to said first and second viewfinder levers.

15. The viewfinder assembly of claim 14 additionally including a plurality of prisms for directing the view of the user around a turn in the viewfinder assembly.

16. A method of assembling the optics in an image capture device including a zoom lens system, comprising:
(a) providing a viewfinder assembly, comprising:
a first viewfinder lens;
a second viewfinder lens aligned optically with said first viewfinder lens;
a cam flat including a first viewfinder guide groove having a first viewfinder lens profile and a second viewfinder guide groove having a second viewfinder lens profile, said cam flat additionally controlling the magnification of a zoom lens;
a first viewfinder lever in communication with said first viewfinder lens and said first viewfinder guide groove;
a second viewfinder lever in communication with said second viewfinder lens and said second viewfinder guide groove; and
an adjustment plate pivotally fixed to said first and second viewfinder levers, said adjustment plate additionally including an accentor pin affixed thereto;
(b) providing a zoom lens plate and fixing said cam flat in place relative to said zoom lens plate stem, said zoom lens plate including a slot;
(c) affixing said accentor pin to said slot to fix said adjustment plate relative to said zoom lens plate; and
(d) rotating said accentor pin to move said adjustment plate relative to said zoom lens plate in order to position said guide levers relative to a desired initial starting position.

17. In image capture device including a diopter adjustment mechanism, comprising:
an image capture device housing;
a diopter adjustment knob accessible through said image capture device housing a rotational cam including a helical ramp, said rotational cam being engaged with said diopter adjustment knob such that rotation of said diopter adjustment knob rotates said rotational cam;
a viewfinder housing located inside said image capture device housing, said viewfinder housing including a hole;
a viewfinder diopter lens movably located in said viewfinder housing and visible through said image capture device housing, said viewfinder diopter lens including an arm extending therefrom, a first face of said arm being located adjacent said helical ramp, a bearing pin extending from a second face of said arm, opposite said first face, the second end of said bearing pin being fixed to said hole of said viewfinder housing; and
a spring mounted coaxially around said bearing pin between said viewfinder housing and said arm to bias a portion of said arm against said helical ramp of said rotational cam;
wherein rotation of said diopter knob rotates said cam, moving said helical ramp and correspondingly, moving said arm and said diopter lens linearly by an amount equal to the change in height of said helical ramp.

18. The image capture device of claim 17, wherein said arm includes a protrusion located on a first face, said protrusion being located adjacent a portion of said helical ramp, wherein said spring biases said protrusion against said helical ramp.

19. The image capture device of claim 18, additionally including a detent mechanism to prevent unintentional movement of said rotational cam.

20. The image capture device of claim 19, wherein the detent mechanism includes a spring including a spring arm, rotation of said rotational cam resulting in rotation of said detent spring arm, and wherein said image capture device housing includes a plurality of detent notches, said spring arm engageable with each of said detent notches.

21. The image capture device of claim 19, wherein said rotational cam is located inside said diopter knob, such that rotation of said diopter knob directly drives said rotational cam.

22. The image capture device of claim 19, wherein said diopter adjustment knob is a toothed gear including a plurality of gear teeth on the circumferential edge thereof, and said rotational cam additionally includes a plurality of gear teeth around the circumferential edge, thereof, the teeth of said rotational cam engaging the teeth of said diopter adjustment knob.

23. The image capture device of claim 22, wherein the detent mechanism includes a spring including a spring arm, rotation of said rotational cam resulting in rotation of said detent spring arm, and wherein said image capture device housing includes a plurality of detent notches, said spring arm engageable with each of said detent notches.

24. The image capture device of claim 23, wherein said diopter adjustment knob additionally includes a limit stop groove and said image capture device includes a limit stop block, said limit stop block sized to travel in said limit stop groove to define the total permitted rotation of said diopter adjustment knob.

25. A diopter adjustment mechanism for an image capture device, comprising:
a diopter adjustment wheel gear including gear teeth, thereround;
a knob gear including teeth thereround, the teeth of said thumbwheel gear being enmeshed with the teeth of said diopter adjustment wheel, said thumbwheel gear including a ramp formed on the rear surface thereof;
a viewfinder optical lens including a follower arm, said follower arm biased in contact with said ramp,
wherein, rotation of said diopter adjustment wheel gear results in linear motion of said viewfinder optical lens.
